(19) United States
(12) Patent Application Publication
(10) Pub. No.: US 2006/0096407 A1
(43) Pub. Date: May 11, 2006

(54) Stem for a bicycle

(75) Inventor: Jim Liao, Hsin Chu Hsien (TW)

Correspondence Address: TROXELL LAW OFFICE PLLC, SUITE 1404, 5205 LEESBURG PIKE, FALLS CHURCH, VA, 22041, US

(73) Assignee: Hsin Lung Accessories Co., Ltd.

(21) Appl. No.: 10/984,760

(22) Filed: Nov. 10, 2004

(51) Int. Cl. B62K 21/12

(52) U.S. Cl. 74/551.1

(57) ABSTRACT

An improved stem for a bicycle comprises an adaptor including a ring portion for securing onto a front fork, and a toothed section; a movable member having one end provided with a locking hole for securing to said ring portion, and another end provided with a toothed section; and a lateral tube having one end provided with a clamp member for securing a handle and another end provided with two toothed sections respectively at both sides thereof for meshing with the toothed section of the adaptor and the toothed section of the movable member after the lateral tube is adjusted to a desired angle.

### BACKGROUND OF THE INVENTION

1. Field of the Invention

The present invention relates to a stem, in particular to a stem for a bicycle which can be adjusted in angle in a convenient and simple manner.

2. Description of the Related Art

FIG. 1 shows a conventional stem of a bicycle which includes a lateral tube 1 soldered onto the peripheral wall at the top end of a vertical tube 2, and the bicycle handle 5 is fixed to a clamp member 4 at the front end of the lateral tube 1. Thus, the angle between the lateral tube 1 and the vertical tube 2 cannot be adjusted at all, i.e., the lateral tube 1 cannot be adjusted in the upward and downward direction and, in turn, the handle 5 secured to the clamp member 4 at the front end of the lateral tube 1 is not adjustable in height and consequently cannot provide satisfactory gripping for riders of different heights. Thus, optimum riding comfort cannot be achieved. There are angle-adjustable bicycle stems available in the market, and the present invention provides an alternative to the prior structures.

### SUMMARY OF THE INVENTION

Accordingly, an object of the present invention is to provide an angle-adjustable stem for a bicycle which can achieve adjustment of the height of the angle of the lateral tube as desired or required by a user.

To realize the above object, the present invention provides an adjustable stem for a bicycle which comprises an adaptor including a ring portion for securing onto a front fork, and a toothed section; a movable member having one end provided with a locking hole for securing to said ring portion, and another end provided with a toothed section; and a lateral tube having one end provided with a clamp member for securing a handle and another end provided with two toothed sections respectively at both sides thereof for meshing with said toothed section of said adaptor and said toothed section said the movable member after said lateral tube is adjusted to a desired angle.

### BRIEF DESCRIPTION OF THE DRAWINGS

Other features and advantages of the present invention will become apparent in the following detailed description of the preferred embodiment with reference to the accompanying drawings, in which:

FIG. 1 is a perspective view of a conventional stem for a bicycle

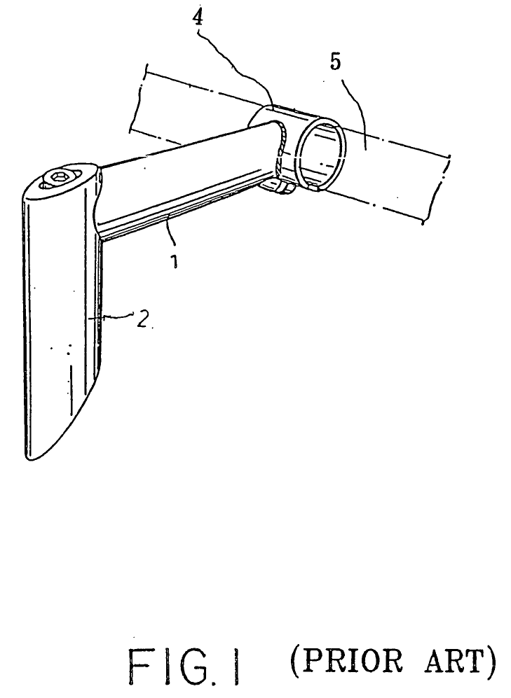

FIG. 2 is an exploded view of a bicycle stem according to the present invention;

FIG. 3 is a perspective view of the bicycle stem according to the present invention; and

FIG. 4 is a sectional view of the bicycle stem according to the present invention.

### DETAILED DESCRIPTION OF THE PREFERRED EMBODIMENT

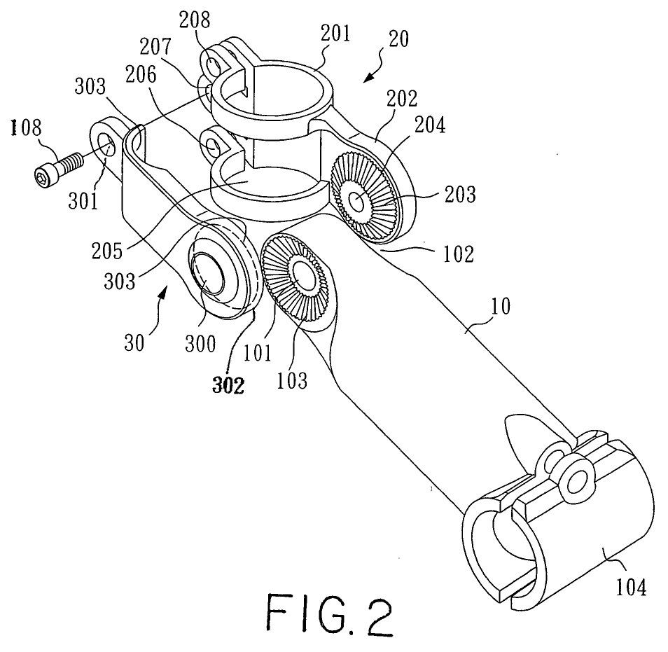

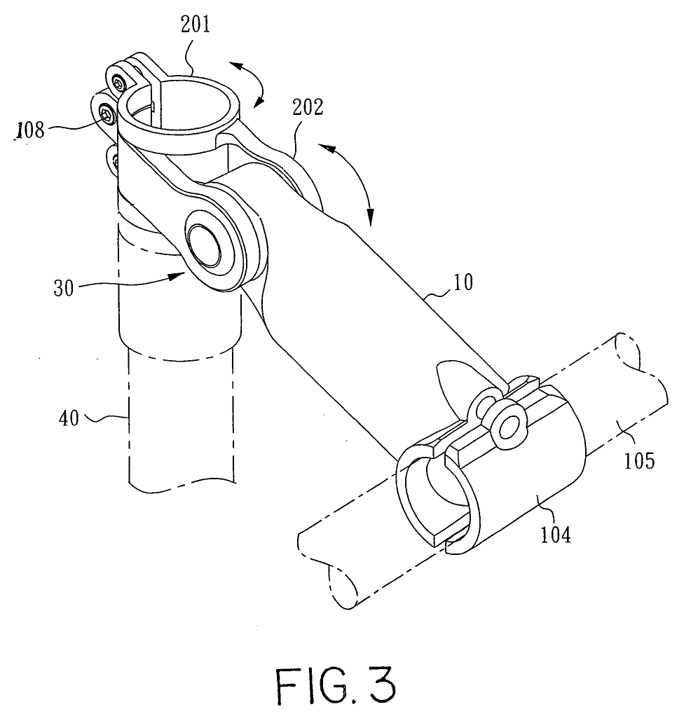

With reference to FIG. 2 in conjunction with FIG. 3, the stem for a bicycle according to a preferred embodiment of the present invention generally comprises a lateral tube 10, an adaptor 20 and a movable member 30.

The lateral tube 10 has one end provided with two toothed sections 102,103 respectively at both sides thereof, with a slot 101 passing through the two toothed sections 102,103, and another end provided with a clamp member 104 for securing a handle 105.

The adaptor 20 includes a ring portion 201 and a fixing portion 202. The fixing portion 202 has one end attached to a side edge of the ring portion 201, and another end provided with a toothed section 203. A bore 204 is provided at the center of the toothed section 203. The ring portion 201 is provided with a recess 205 and a plurality of locking holes on a side thereof In this embodiment, three such holes 206,207,208 are illustrated.

The movable member 30 has one end provided with a locking hole 301 and another end provided with a toothed section 302 having a through-hole 300, and further has an arcuate portion 303 formed at the middle portion thereof When the ring portion 201 of the adaptor 20 is sleeved onto the front fork 40, the locking holes 206,208 are first tightened to lock by a threaded rod, and this secures the ring portion 201 onto the front fork 40. Then, the lateral tube 10 is adjusted to the required angle, and thereafter the toothed section 102 of the lateral tube 10 and the toothed section 203 of the fixing portion 202 are meshed in engagement. In turn, the movable member 30 is pressed against the ring portion 201, such that the toothed section 302 of the movable member meshes in engagement with the other toothed section 103 of the lateral tube 10 and, at the same time, the locking hole 301 of the movable member 30 is aligned with the locking hole 207 of the ring portion 201. Athreaded rod 108 is inserted through these holes to lock. In another aspect, locking may be done by a bolt inserted through the through-hole 300, slot 101 and bore 204 of the respective toothed sections 302,103,203. Thus, the lateral tube 10 is clamped between the fixing portion 202 and the movable member 30. Consequently, the lateral tube 10 is fixed and immovable.

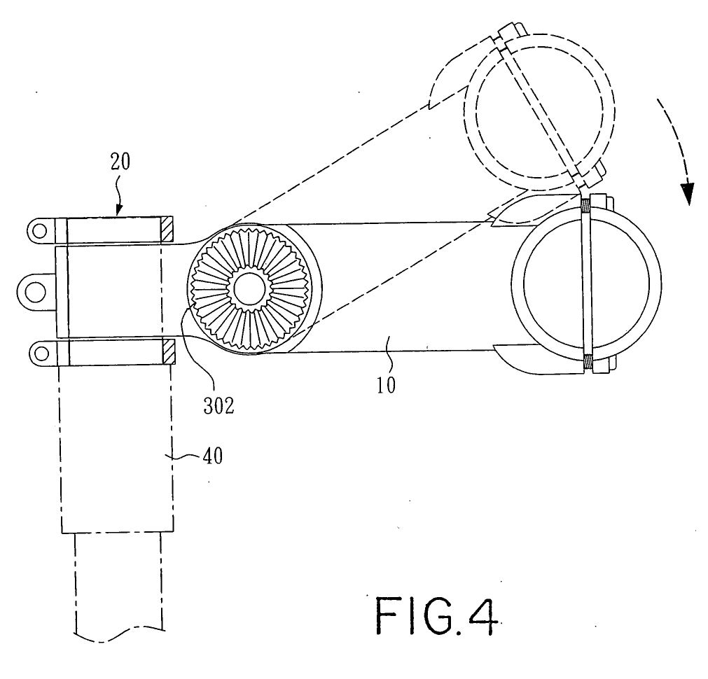

Once it is desired to adjust the angle of the lateral tube 10, it is necessary only to loosen the threaded rod 108 in the locking hole 301 which locks the movable member 30, as well as the bolt in the toothed section 302, and then release the engagement of the toothed section 102 of the lateral tube 10 with the toothed section 203 of the fixing portion 202 (at this point the adaptor 20 is still fixed on the front fork 40). The lateral tube 10 then can be adjusted up and down to the required angle (see FIG. 4). Thereafter, the movable member 30 is pressed and locked, and the angle adjustment of the lateral tube is accomplished.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An improved adjustable stem for a bicycle for securing a handle and a front fork, respectively, comprising:
a lateral tube having one end provided with two toothed sections respectively at both sides thereof, and another end provided with a clamp member for securing said handle;
an adaptor including a ring portion for securing onto said front fork, and a fixing portion having one end attached to a side edge of said ring portion and another end provided with a toothed section for meshing with one of two toothed sections of said fixing portion; and
a movable member for pressing against said ring portion when said ring portion is sleeved onto said front fork and after said lateral tube is adjusted to a desired angle.

2. An improved stem for a bicycle as claimed in claim 1, wherein said movable member has one end provided with a locking hole for securing to said ring portion, and another end provided with a toothed section for meshing with the other of two toothed sections of said fixing portion.
